(19) United States
(12) Patent Application Publication
(10) Pub. No.: US 2013/0250142 A1
(43) Pub. Date: Sep. 26, 2013

(54) DEVICE AND METHOD FOR FLEXIBLY ASSOCIATING EXISTING READABLE SURFACES WITH COMPUTER AND WEB-BASED SUPPLEMENTAL CONTENT

(71) Applicant: Sean Elwell, Woodbury, CT (US)

(72) Inventor: Sean Elwell, Woodbury, CT (US)

(21) Appl. No.: 13/424,903

(22) Filed: Mar. 20, 2012

(51) Int. Cl. H04N 5/76

(52) U.S. Cl. 348/231.99; 348/E05.024

(57) ABSTRACT

A method and a device is provided for reading visual cues from a variety of readable surfaces, associating those visual cues with digital files stored on the device, and subsequently providing an output of those digital files to the user. These digital files may be in the form of audio, video, pictures, and other formats that may be used to enhance the learning experience of the user while observing the readable surface.

### FIELD OF INVENTION

The present invention relates broadly to a device and method for detecting features of an object provided on a surface, and more particularly to a device and method that reads objects from a surface and takes action according to features identified about the object.

### BACKGROUND OF THE INVENTION

Digital object recognition is the task of finding a given object in an image, medium, surface, video or other situations. Humans recognize a multitude of object images easily and take action according to recognizing the nature of the object. However, there are many circumstances where human eye or human recognition needs to be supplemented using a computing device. There may be a multitude of reasons for this need. For example, in medical arts, a human eye cannot, without the help of a microscope, detect small objects. Similarly, in the same medical circumstances, a human mind may not be able to recognize features of a diseased organ instantly without consulting other references. In such situations, viewing and recognition of an object can help both with better human decision making and aid in learning.

Medical environments are only one of a great many fields where digital object recognition can be utilized. Another area where object recognition is leaving a big impact is in the area of education. Use of printed materials for learning is being replaced as new information is discovered and old methods of learning are altered. Billions of dollars of textbooks currently in circulation in schools and libraries are becoming obsolete with time. “Active learning” is an umbrella term that refers to several models of instruction that focus the responsibility of learning on learners. It has been suggested that users who actively engage with the material they are reading will be more likely to recall information and will experience an enhanced level of learning. Printed books also under-serve the reader by failing to integrate valuable web based supplemental content and foreign language translations into the information they provide.

The problem with use object recognition in these and many other fields is not so much with the object recognition technology but with dissemination of information in such a way that decision making can be conducted in a superior and precise manner when the object is identified. The prior art does not currently provide for such a system. For example, presently there is no good way to integrate printed books with up-to-date information that is available in web-based supplemental content. Another issue is having systems that perform such a function in a practical, easy to use and cost effective manner. For example, there is no good technology currently that can retroactively allow English language printed textbooks to instantly translate into other languages.

Consequently, there is a need to provide a cost effective, up to the minute system that can provide information in a way that a digital object recognition method and apparatus can utilize to aid human decision making to create one or more desired outputs.

### SUMMARY OF THE INVENTION

The shortcomings of the prior art are overcome and additional advantages are provided through the provision of a method and device for reading unique visual cues from any readable surface and associating pre-stored images obtained from the surface with media files that are presented to the device user as supplemental material related to the information that is present on the readable surface, thereby providing additional content to the user and giving the user a more fulfilling experience while learning about the materials being studied.

The present device shines two or more lights onto any readable surface while an internal optical sensor “looks” at that surface, much like a human eye, scanning for visual cues that may be pre-stored in the device's memory in a library of images. The device then associates existing surface images with rich media and web-based content. Supplemental web-based content may include, but is not limited to: contextual explanations, voices and other sounds, language translations, content highlighting and historical context.

The device may be used to access and play audio content while in solo mode, in tandem with a computer, or it can be used to “author” titles by programming specific features from any readable surface that will initiate the playing of supplemental or complementary media files or provide access to web based media according the programmer's preferences.

The device plays supplemental rich media content and web-based content through an onboard means and may also initiate the projection of additional electronic content via a video screen, head phone jack, and/or speakers of any paired computing device. Because the device may be programmed to recognize elements of printed media, the underlying technology can substitute many current applications for bar codes and optical character recognition.

Additional features and advantages are realized through the techniques of the present invention. Other embodiments and aspects of the invention are described in detail herein and are considered a part of the claimed invention.

### BRIEF DESCRIPTION OF DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is an illustration of the external view of the device employed to read a surface;

FIG. 2 is an illustration of the internal components of the device employed to read a surface;

FIG. 3A is an illustration depicting how the device is used in the solo play mode;

FIG. 3B is an illustration depicting how the device is used in the tandem play mode;

FIG. 4A is an illustration of one embodiment of the present invention depicting how the device is used to match unique images that may consist of a portion of a picture on the readable surface;

FIG. 4B is an illustration of one embodiment of the present invention depicting how the device is used to match unique images that may consist of a portion of a text passage on the readable surface.

### DETAILED DESCRIPTION

The present invention is an apparatus and associated method whereby an optical reader device may be used to scan the surface of any optically readable object, detect one or more optically unique images that are already present on the surface being scanned, store those unique images in a memory location, and be programmed to associate those optically unique images to computer media files and/or web-based content. After the device is programmed, the device may then be employed by a subsequent user who will use the device to scan the optically readable object to search for previously stored images. Upon detecting these optically unique visual cues and matching them to the images previously stored in the device's library of images, the device will generate the associated preselected output that can involve video, audio, mechanical or computer based actions including execution or display of information obtained from one or more computer files or web-based content. All generated output that is related to the readable feature that was detected on the surface. This output will supplement the learning experience for the user by providing additional information about the subject being explored based on the unique visual image that was detected by the device or maybe a translation of the information to another language of the user's preference.

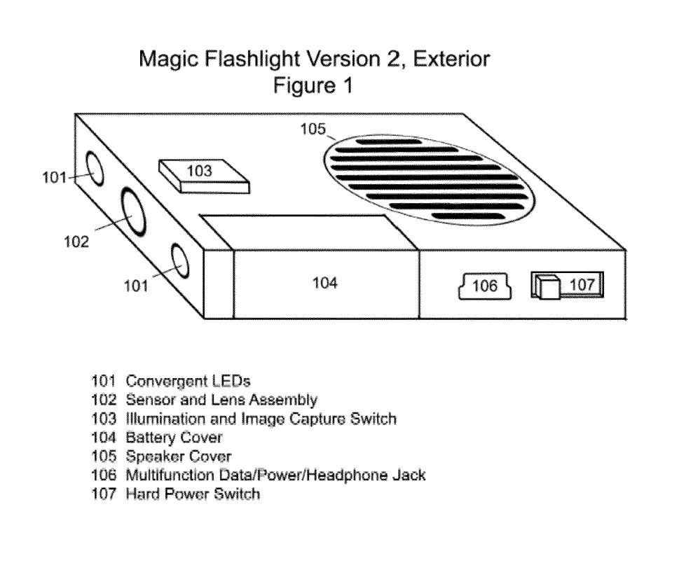

In accordance with an embodiment of the present invention, FIG. 1 is an illustration of the external view of the device employed to read a surface. The device has two or more convergent lights 101 located on one end of the device. These lights are used to determine the optimal distance that the device should be located from the readable surface during use so that the images processed by the device will be in focus and readable by the device. Located on the same end is the lens and sensor assembly 102 that is used to collect images from a readable surface. The images collected will be used in two ways: initially, they are used to program the device by collecting images that will be associated with digital files stored in the device's memory that relate to the material on the readable surface; after programming, they will be used to compare with previously stored images in the device's memory to provide an output to the user that will supplement and enhance the information present on the readable surface. An illumination and image capture switch 103 is located on the device that turns on the lights and initiates the capture of images from the readable surface by the device. The device can be supplied with electricity in a number of ways such as through and outlet, though solar means or friction, or by means of supplying a battery or generally through other methods as known by those skilled in the art. In embodiments where a battery is supplied. the device can also include a battery compartment and a battery cover 104 that provides easy access to the battery compartment and a speaker cover 105 that protects the internal speaker for output of sound files. In some embodiments, the device can also be provided with a multifunction jack 106 that may allow for transfer of data, provide power, and/or accommodate headphones for the user to privately listen to audio output. A hard power switch 107 is located on one side of the device as well.

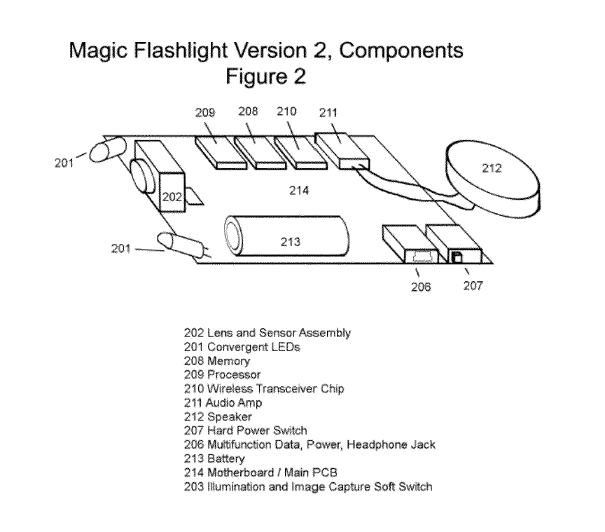

In accordance with an embodiment of the present invention, FIG. 2 is an illustration of the internal components housed within the interior of the device employed to read a surface. This illustration depicts individual components of the device that are connected to a motherboard 214. Located on one end of the motherboard are two or more convergent lights 201 that are used to determine the optimal distance the device should be located from the readable surface during use. Located on the same end of the motherboard 214 is the lens and sensor assembly 202 that is used to collect images from a readable surface. These images will be used to compare with previously stored images in the device memory to associate surface features with a stored electronic file that provides an output to the user.

In one embodiment of the present invention the illumination and image capture soft switch 203 that turns on the lights and initiates the capture of images from the readable surface is located just behind the lens and sensor assembly 202. In this embodiment, the device has a multifunction jack 206 that may allow for transfer of data, provide power, and/or accommodate headphones and a hard power switch 207 which can be located anywhere such as on one side of the device as shown. One or a plurality of microchips can also be disposed inside such as on a motherboard 214 that may include one or more of each of the following: a memory chip 208 for storing programs and images, a processor chip 209 in communication with the memory and other components, a wireless transceiver chip 210 to provide for wireless communication with a computing device, and an audio amplifier 211 used to drive the enclosed speaker 212 for audio output. Since in this embodiment, the device is battery operated, the device also houses a battery 213 on the motherboard 214.

In one embodiment of the present invention, the device can also be used to scan an optically readable object to look for certain features that might be present on the surface. When these features are detected, they are then compared to a set (or sets) of parameters that have been preloaded into the device. When the readable feature matches the parameters (or some percentage of parameters that would be considered a match) stored within the device's memory, the device will then execute the associated file related to the parameter match to output some useful information to the user about the readable feature that corresponds to the parameters. These parameters could be related to size, shape, color, or any other distinguishing characteristic of the visually unique image that can be detected by the device.

In accordance with one embodiment of the invention, the optical multimedia device may be programmed to recognize unique visual cues within pre-existing printed materials, such as textbooks. The device shines one or more lights onto the printed textbook pages while an internal optical sensor looks at the pages, scanning the material for visual cues that are pre-stored in the device's library of images. Two or more lights are needed for the device to establish the optimal distance (or range) from the readable surface and to illuminate the surface for the user. When the lights converge on the surface, the user will know that the device is at the optimal sensing distance. The device can then associate the existing print products with electronic files stored in the memory, or access web-based content stored on an associated computing device. These files or web content might include further information about the topic or even foreign language translations of the text.

The device may be developed to accommodate several operational modes. These operational modes include stand alone use where the device is used by itself to scan a readable surface and provide an output to the user. The device may also be used in a tandem mode where the device is connected and used in conjunction with another computing device. The device may also be used in a mode that allows the user to “author” titles by scanning an existing textbook or other readable surface to look for optically unique visual cues already present on the page surface that can be stored in the memory of the device and associated with a variety of electronic file types.

One embodiment of the device may be operated in a mode called Authoring Mode. In this mode, the user scans the device over the readable surface to search for unique visual cues found on the surface and then programs the device to associate these detected visual cues to a stored file or associated web-based media. Later, when a subsequent user is scanning the same area of the surface with the device and the optical sensor recognizes a specific visual cue that was previously programmed into the device, the device will call up the associated media file or web based content, and play that as an output on a corresponding audio or video appliance. Visual cues that this device recognizes can be anything that has a unique configuration on the page or any other readable surface. The visual cues may consist of images, fractions of images, captions, page numbers, 2D and 3D symbology, invisible ink, and other text. Anything visually unique is eligible to be treated as a unique visual cue to trigger subsequent actions such as playing a media file or calling up a web page.

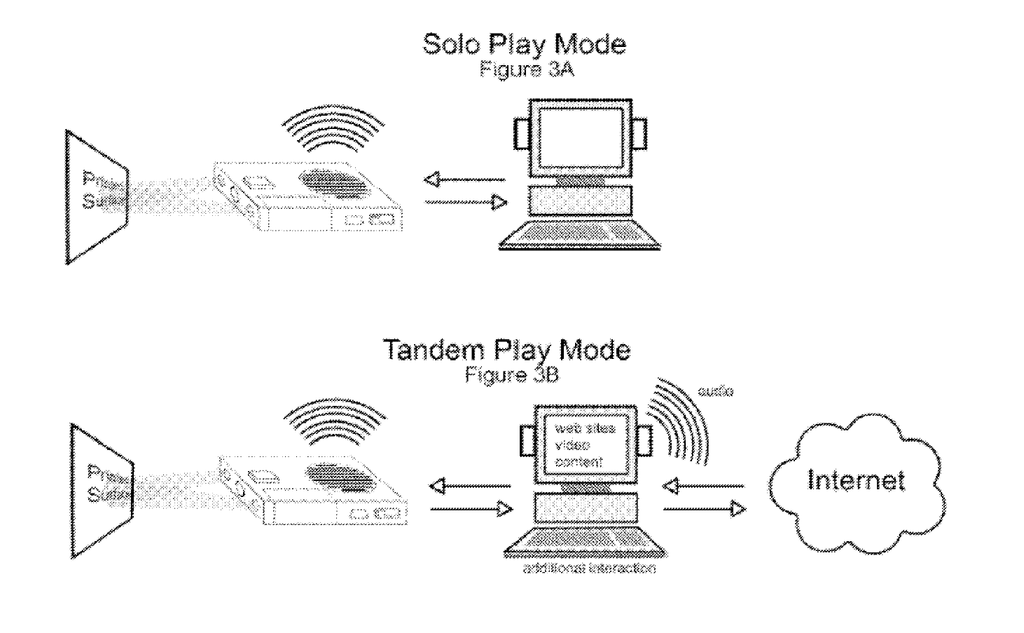

In accordance with an embodiment of the present invention, FIG. 3A is an illustration of how the device may be operated in a mode called Solo Play Mode. This embodiment must incorporate and may only be used following the procedure described above in the Authoring Mode. In Solo Play Mode the device 302 is used to scan the pages of the book or any other readable surface 301. The device's optical sensor will scan the surface to attempt to detect any pre-programmed visual cues by comparing optically readable images to its internal library of pre-programmed images. When a pre-programmed visual cue is discovered, the device will play the appropriate sound file or display the image file on the device itself. The sound may be heard by means of an onboard speaker or with the aid of a wireless earpiece. Sound files may include such features as foreign language translations, contextual explanations, historical context, voices, updated topical information, expanded content, or any other sounds that the programmer wishes to include. Video or image files may also be stored and later viewed by means of an onboard video screen. During Solo Play Mode the device is using a paired computing device 303 to assist with higher level processing, but all media output would only occur on the reader device itself. Once captured images are matched and decoded, media files pertaining to the material on the readable surface will be transferred from the paired computing device to the reader device for output.

In accordance to an embodiment of the present invention, FIG. 3B is an illustration of how the device may be operated in a mode called Tandem Play Mode. This embodiment must incorporate and may only be used following the procedure described above in the Authoring Mode. In Tandem Play Mode, the device 305 will work together with a book or any other readable surface 304 and any kind of personal computer, smartphone, tablet, or any other internet-enabled computing device 306 that has the appropriate computer program to interface with the device installed in advance. This embodiment of the present invention will also utilize a connection to the internet 307 as part of the system. The internet connection may be accomplished with a physical connection, such as a USB 2.0 cable or alternatively, a wireless method of pairing such as Bluetooth™. As the user shines the light from the device 305 onto the readable surface 304 to capture the pre-programmed visual cues, the device 305 can play onboard or web-originated audio and text translations locally using either the onboard speaker or remotely on the audio and/or video output device of the paired computer. Also the device can call up web pages that have been pre-loaded into the device's library of files and display the web originated digital content onto the paired computer. Video files may be played onboard the device, on the screen of the coupled computing device, or through a projector onto a large screen for presentation to groups.

In one embodiment, the device is used by a student in tandem play mode along with a computer application running on the paired computer such as a Smartphone or laptop computer. The handheld device, wirelessly paired with the internet connected computing device, may allow the student to search the internet via the links provided in order to access supplemental information on the topic that is currently being explored. In the described embodiment, the student may only access the web via links that have been previously programmed for that experience. An advantage of this embodiment is the ability to allow the student the benefit of web-based supplemental content while simultaneously preventing the student from wasting time as a consequence of freely surfing the web. The described embodiment offers the potential to keep the computer secure from unguided surfing and ensures that the student remains focused on the current topic being studied. The users may alternatively configure the program to allow tangential or free web surfing while using the device via the paired computer if so desired.

In the tandem play mode the use of the device is not limited to pairing with a conventional personal computer. The device may also be paired with a cell phone, PDA, smartphone, other handheld portable computer, or router. Upon pairing the device with any portable computing device, old paper textbooks or other dated readable materials may be repurposed into topically focused, 21^{st} century web portals. This pairing of devices will allow older materials to be continually updated and supplemented to reflect technological advancements and new information that may have been discovered since the original work was written. This updated material is then presented to the user of the device to allow the user to obtain the most up-to-date information about the subject being explored.

Another advantage of pairing the handheld device with a second computing device is that the ancillary computing device may be used in such a way as to enhance processing speed and provide the needed internet connection. The enhanced processing will assist the device with image matching and decoding as it is used to scan and read the optically readable surfaces.

In one embodiment of the invention, the device will be used to scan surfaces to find objects that meet a pre-programmed set of parameters and will not be limited to optically unique visual cues that have been previously programmed into the device by previous scanning of the readable surface. One such use of the device may be in the field of medical screening. In one embodiment, the device may be used to scan the surface of a patient's skin to evaluate moles or other skin irregularities that may be present. The device will then compare the mole scanned on the surface of the skin with the pre-programmed set of parameters, which might trigger a response that could alert the patient whether or not the mole is potentially cancerous and whether the patient should seek further medical help. In this particular example, the criteria that could be pre-programmed into the device might follow the ABODE [American Academy of Dermatology] method for screening moles. The device could then be used to compare the scanned moles for parameters related to asymmetry, evaluate the mole to determine if the border is smooth or irregular, detect the color of the mole, measure the diameter of the mole, and finally determine if the mole is elevated from the surrounding skin surface. When a certain pre-determined percentage of the parameters are met, the device would then alert the user and suggest follow up actions depending on the completeness of the match. The device could also be configured such that the image would trigger a web search for related supportive content. As an example, the device could be used to detect a mole, identify warning signs for melanoma within the captured images, call up web based content in support of a diagnosis of melanoma or send certain flagged images off to a remote dermatologist for an additional level of scrutiny.

The method of image matching for this device uses a software algorithm. The algorithm will look at various parameters to establish the unique visual cues that will be stored into the device's library of images. Global image features can be used, which may include, but are not limited to, average color, color gradients, and low frequency Fourier components. The algorithm will also detect and utilize other image features that might exist on the optically readable surface, such as edge detection, corner detection and detection of other small-scale image features.

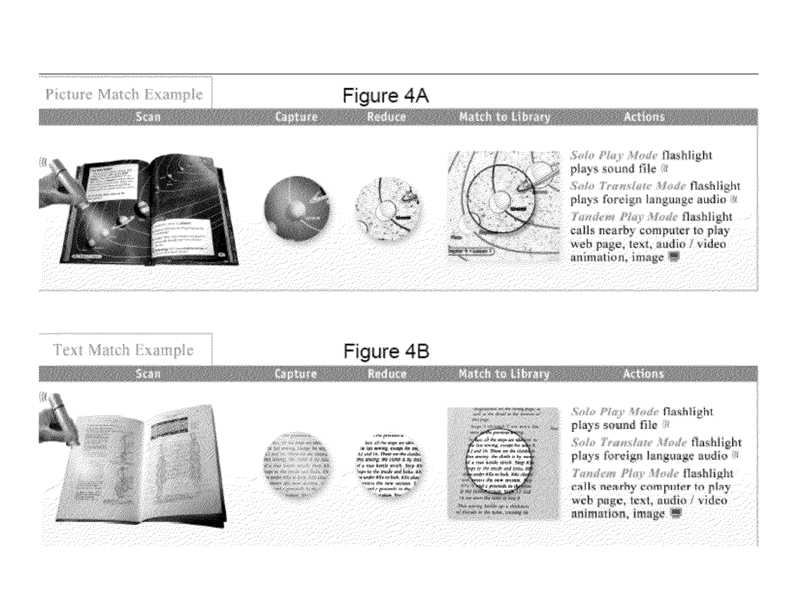

In accordance with one embodiment of the present invention, FIG. 4 is an illustration that depicts methods of image matching used in the present invention. FIG. 4A depicts how the device in one embodiment of the present invention is used to match unique images that may be a portion of a picture. FIG. 4B is an illustration depicting how the device in one embodiment of the present invention is used to match unique images that may be a portion of a text passage.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. A portable device comprising:
a processor in communication with a memory;
an illumination source;
an optical component in processing communication with said processor for capturing optical input by using said illumination source;
said processor retrieving and storing said images from said optical component and storing them in a memory location in said memory;
a comparator in processing communication with said processor that compares captured images with information previously stored in the memory;
at least one output mechanism for processing communication with said processor for expressing an output related to stored information based on the analysis or findings of the comparator suggesting said output.

2. The portable device of claim 1, wherein said illumination source consists of two or more lights that illuminate said surface and are set in such a manner to converge at a set distance from said device and said images are captured from a readable surface.

3. The portable device of claim 1, wherein said optical component is any device that is capable of detecting images present on said readable surface.

4. The portable device of claim 1, wherein said readable surface is any surface that reflects light in order to produce an image that is detectable by said optical component.

5. The portable device of claim 1, wherein said images may include any unique visual cue that is present on said readable surface that may be detected by said optical component.

6. The portable device of claim 5, wherein said unique visual cue includes, but is not limited to, images, fractions of images, captions, page numbers, other text, symbols, signature inks, and/or any visually unique element.

7. The portable device of claim 1, wherein said device may be operated in a manner where it is connected to an external computing device.

8. The portable device of claim 7, wherein said external computing device may be connected by any means available, including, but not limited to, a hardwired connection, a wireless connection, and/or a Bluetooth™ connection.

9. The portable device of claim 7, wherein said external computing device may be any kind of personal computer, smartphone, tablet, or any other internet-enabled computing device that has the appropriate computer program to interface with the portable device installed in advance.

10. The portable device of claim 7, wherein said external computing device may be utilized to provide enhancements in processing speed and/or memory that will assist with image matching and decoding for said portable device.

11. The portable device of claim 1, wherein said device may be scanned over said readable surface to detect said images that are present at various locations on said readable surface with said optical component and store said images in said memory locations.

12. The portable device in claim 11, wherein each said image detected and stored can be associated with a unique digital file by a user.

13. The portable device in claim 12, wherein said digital file may be of various formats, including, but not limited to, documents, images, audio, and/or video.

14. The portable device of claim 11, wherein when said optical component detects said image stored in a memory location, said portable device can use an onboard comparator to associate said image to one or more said digital files and execute said file.

15. The portable device of claim 1, wherein said previously stored information may be either images previously captured by said device and stored in a memory location or may be preloaded image parameters, including but not limited to, size, shape and/or color, preprogrammed into a memory location.

16. The portable device of claim 1, wherein said output may be either output suggested from a preselected list already stored in a memory location, output suggested from a pre-stored image previously captured by said portable device and stored in a memory location, and/or output that is provided when there is no match determined by said portable device.

17. The portable device of claim 16, wherein said output onboard said portable device may be audio and/or video.

18. The portable device of claim 16, wherein said output on a paired computing device may be audio, video, a Braille display, and/or any media type to support traditional print media.

19. A method for analyzing an image captured from a readable surface and providing a suggested output, comprising:
using a portable device having an illumination source and an optical component in communication with an onboard processor;
capturing an image from said readable surface with said portable device;
storing said image in a memory location;
associating said stored image with one or more digital files that will later provide said suggested output to said portable device user;
scanning said readable surface at a later time;
capturing many images with said portable device;
comparing said captured images to images that were previously stored in said memory location;
searching said memory locations of said portable device for a match of said image;
finding a match resulting in said portable device recalling said individual digital file that is associated with said stored image match and providing said suggested output to the user of said portable device;
failing to find a match resulting in said portable device providing a default output indicating that no match was present.

20. A method for analyzing an image captured from a readable surface and providing a suggested output, comprising:
using a portable device having an illumination source and an optical component in communication with an onboard processor;
storing image search parameters in a memory location;
associating said image search parameters with one or more digital files that will later provide said suggested output to said portable device user;
scanning said readable surface at a later time;
collecting many images with said portable device;
comparing said images to said image search parameters that were previously stored in said memory location;
searching the memory of said portable device for a match to said previously stored image search parameters;
finding a match resulting in said portable device recalling said individual digital file that is associated with said image search parameters that match characteristics of said image and providing said suggested output to the user of said portable device;
failing to find a match resulting in said portable device providing a default output indicating that no match was present.
